(19) United States
(12) Patent Application Publication
(10) Pub. No.: US 2024/0205516 A1
(43) Pub. Date: Jun. 20, 2024

(54) VIDEO CAPTURE, PRODUCTION, AND DELIVERY SYSTEMS

(71) Applicant: Captuure, Inc., Windermere, FL (US)

(72) Inventors: John Ehrhard, Windermere, FL (US); Duncan Platt, Clemont, FL (US); Andre Forde, Orlando, FL (US); Senthil Kumar, Chennai (IN); Zeeshan Ahmed, Multan (PK); Xin Cun, Shenyang (CN)

(73) Assignee: Captuure, Inc., Windermere, FL (US)

(21) Appl. No.: 18/554,274

(22) PCT Filed: Apr. 7, 2022
(86) PCT No.: PCT/US2022/023909

§ 371 Date: Oct. 6, 2023

Related U.S. Application Data
(60) Provisional application No. 63/172,431, filed on Apr. 8, 2021.

(51) Int. Cl. H04N 21/854; G11B 27/031

(52) U.S. Cl. CPC H04N 21/854; G11B 27/031

(57) ABSTRACT

Audiovisual content creation systems and methods are provided. According to some methods, a client device is caused to present a video capture interface on a display of thereof, the video capture interface presenting at least one question and prompting a recipient to record an audiovisual data segment. The audiovisual data segment recorded on the client device are then received, at least one content block is produced based upon the audiovisual data segment and a production ruleset, and the content block is delivered to one or more recipient devices.

### CROSS REFERENCE TO RELATED APPLICATIONS

This application claims the benefit of U.S. provisional patent application No. 63/172,431, filed Apr. 8, 2021, the entire contents of which are hereby incorporated by reference.

### BACKGROUND

Video is an extraordinarily valuable medium to capture emotion, personality, memories, endorsements, and other content. However, it is difficult for most people to create professional, entertaining, and engaging video content, which requires specialized talent and labor-intensive and expensive production techniques. Therefore, a need exists for systems and methods that enable a individuals and groups to create powerful, captivating video content, and to deliver that video content to their colleagues, families, friends, and broader audiences.

### SUMMARY

In an aspect, the present disclosure provides systems and methods for creating and delivering highly impactful video content in many different applications, including enterprise and social settings. According to some embodiments, the video capture systems utilize guided, template-based prompts that elicit impactful responses from one or more recipients, which are recorded as raw audiovisual data segments. The disclosed systems implement production and editing procedures to transform the raw audiovisual data segments into professional quality, captivating video content.

### BRIEF DESCRIPTION OF THE SEVERAL VIEWS OF THE DRAWINGS

The foregoing aspects and many of the attendant advantages of the claimed subject matter will become more readily appreciated by reference to the following detailed description, when taken in conjunction with the accompanying drawings, wherein:

FIG. 1 shows a schematic overview of an audiovisual content creation system and methods for producing audiovisual content according to an embodiment of the present disclosure.

FIG. 2 shows aspects of a representative content capture engine of an audiovisual content creation system, and methods for producing audiovisual content, according to an embodiment of the present disclosure.

FIG. 3 shows aspects of a representative content production engine and a content delivery engine of an audiovisual content creation system, and methods for producing audiovisual content, according to an embodiment of the present disclosure.

FIG. 4 shows a representative schematic of an audiovisual content creation system architecture according to an embodiment of the present disclosure.

### DETAILED DESCRIPTION

The following description provides audiovisual content creation systems and methods for producing audiovisual content. Said systems and methods are occasionally described with reference to a number of representative and non-limiting use cases. To facilitate understanding, alike reference numerals used through this description have alike meanings unless stated otherwise.

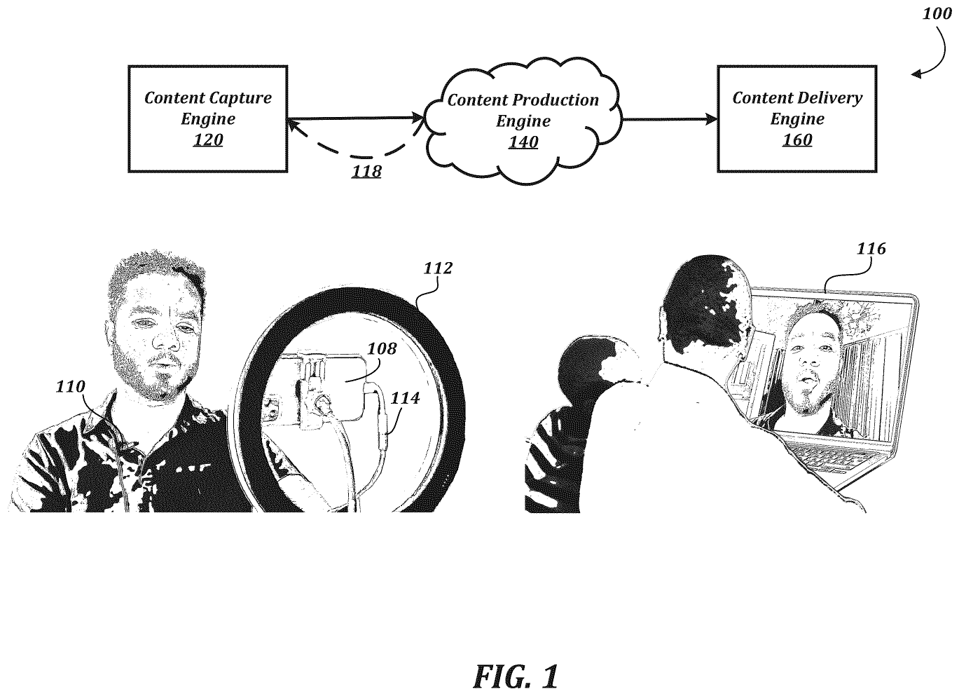

FIG. 1 shows a high-level overview of an audiovisual content creation system 100 according to a representative embodiment of the present disclosure. The audiovisual content creation system 100 implements the methods for producing audiovisual content described herein that enable one or more recipients to create and deliver highly impactful audiovisual content to one or more recipients, for example colleagues, friends, family, the public, and organizations.

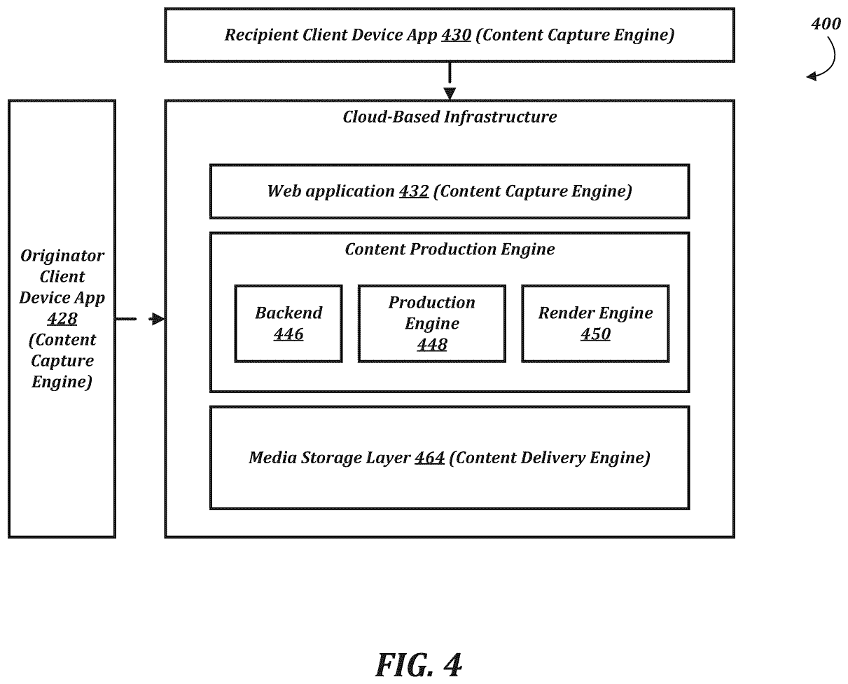

In some embodiments, the audiovisual content creation system 100 is implemented on one or more computing devices programmed with logic that executes the methods described herein. A representative architecture for the audiovisual content creation system 100 is shown in FIG. 4.

### Overview

The three main stages or engines of the audiovisual content creation system 100 include: a content capture engine 120, a content production engine 140, and a content delivery engine 160. To further enhance the quality of the audiovisual data segments, any embodiment of the audiovisual content creation system 100 may include one or more of: a client device 108 (e.g., a smartphone or a laptop), a microphone 110 (such as a smartphone microphone or a lavalier microphone), a light 112 (such as a smartphone flash light or a ring light), and/or a client device stand 114 for the client device.

As used herein, audiovisual data segments include information having both a video component and an audio component stored in an audiovisual format such as .mp4, .mov., .avi, and the like. The terms “video” and “audiovisual” are used interchangeably herein.

The content capture engine 120, content production engine 140, and content delivery engine 160 are introduced briefly below and described in detail thereafter.

Content capture engine 120 presents a video capture interface to one or more recipients on the client device 108 such as a smartphone, tablet, laptop, or desktop, and prompts the recipient(s) to record and submit one or more audiovisual data segments in response to one or more template-based questions. The video capture interface may be presented through a native application on the device (as through a bot within the application) and/or through a web application accessed through a browser on the device. In any embodiment, the video capture interface is first initiated or originated by a third party originator, e.g., through a second client device.

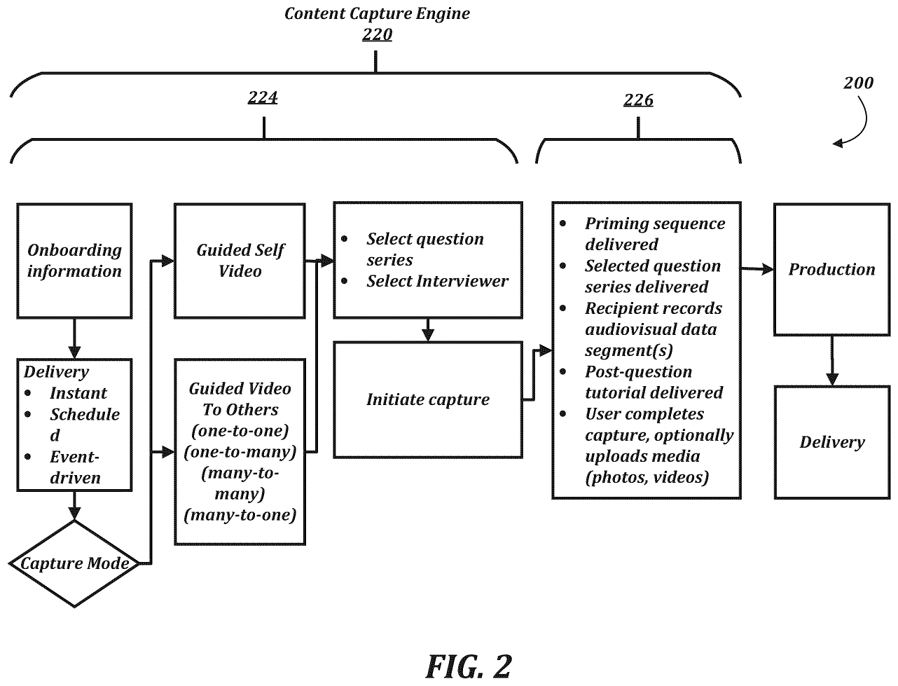

The video capture interface guides the recipient through the content capture engine 120 such as shown in FIG. 2 and described below. The video capture interface presents one or more template-based questions as a text prompt and/or optionally as one or more guided, pre-recorded video prompts on a display of the client device 108. The question(s) is presented in such a manner that prompts the recipient(s) to record thoughtful and articulate responses. When the recipient indicates that they are ready to answer the questions (such as by pressing a record button on the video capture interface), the application records the recipient's responses as raw audiovisual data segments.

The video capture interface presents the recipient (or a group of recipients) the template-based questions based upon one or more video capture template option selections made by the originator. That is, the originator first initiates the capture, production, delivery sequence on a second client device by choosing from at least one video capture template option selection. Based upon the video capture template option selections made by the originator, the video capture interface presents one or more questions on the recipient's client device. In response to the questions, the recipient(s) speaks answers, which are recorded by an image sensor and microphone of the client device 108 as one or more raw audiovisual data segments.

The video capture template option selections predetermined by the originator may include, for example, a theme (such as a topic, genre, brand), style (an artistic overlay with audio and/or visual elements, which may include the selection of an “interviewer” who presents the questions as pre-recorded video prompts through the video capture interface), a number of recipients (single/group), and/or recipient identities. The content of the questions and the manner in which the questions are delivered to each recipient via the video capture interface on their client device is based at least in part upon the video capture template option selections made by the originator on their own client device. The content capture engine 120 optionally enables users such as the originator or a developer to customize the video capture interface by adding new questions and/or deleting one or more questions via a video capture template editor.

Content production engine 140 receives one or more raw audiovisual data segments from the content capture engine 120 and produces audiovisual content blocks based upon a production ruleset, which may be based on the video capture template option selections made by the originator. In particular, the content production engine 140 implements editing and production processes on the raw audiovisual data segments captured by the content capture engine 120. Representative content blocks include, for example, messages curated for an individual, organizational media (human resources onboarding videos, interviews, messages to employees), game shows, mini episodes, gamified Q&A sessions, commercials, television features, journalistic interviews, and documentaries. Representative production methods implemented by the content production engine 140 are described below. In some embodiments, content production engine 140 is a cloud-based computing system implemented on a server-less and/or server-based architecture such as shown in FIG. 4.

Content delivery engine 160 encrypts, stores, and delivers the content blocks produced by the content production engine 140 to the one or more predetermined recipients, who view the content blocks on their own client devices 116 such as a browser-based client on a smartphone, tablet, laptop, or desktop computer. In particular, the content delivery engine 160 delivers the video content blocks on-demand, at a time previously scheduled by the recipient who created the audiovisual data segments, based upon the occurrence of an event triggered by a third party (such as the promotion of an individual within an enterprise organization), or based upon another trigger. Thus, the content delivery engine 160 securely stores and delivers the content blocks at a time selected for maximum impact to the recipient (s).

In some embodiments, production content delivery engine 160 is implemented on a cloud-based computing system, such as a server-less and/or server-based architecture such as shown in FIG. 4. In some embodiments, the content delivery engine 160 delivers the content blocks by hosting such content blocks and enabling one or more recipients to access the content via a browser-based client. In some embodiments, the content delivery engine 160 delivers the content blocks by sending the content blocks to one or more third party platforms, such as third party social media platforms.

### Use Cases

The audiovisual content creation systems described herein have many use cases, some of which will now be described briefly. It shall be appreciated that the use-cases described below are representative, not limiting.

As one example, the audiovisual content creation system 100 is configured as a human resources platform for an enterprise organization, which enables the organization to improve workplace culture, to conduct employee and candidate interviews, and to generally communicate with the workforce. For example, an originator (e.g., a human resources employee) originates the capture process through the originator's client device (e.g., through a bot installed on the originator's messaging platform) by choosing from at least one video capture template option selection, including a theme, a style, a number of recipients, and/or a delivery option. In response, as just one example, the originator may select a birthday theme, a festive style, and may designate that all employees of a particular department shall receive the video capture interface.

After the originator has made the requisite video capture template option selections, the originator initiates the content capture engine 120 to cause the client device of each recipient to display a video capture interface presenting at least one question, such as “What birthday message would you like to share with John?” In some embodiments, the client device of each recipient prompts the recipient (such as through a bot on the recipient's messaging platform) to access the video capture interface (such as through a web browser on the recipient's client device). In response, each recipient may initiate their client device to record an audiovisual data segment in which the recipient answers the question. After the recipient completes recording the audiovisual data segment(s) responsive to the question(s), the recipient may confirm completion of the recording, which prompts the audiovisual data segment to be sent to the content production engine 140.

In some embodiments, before the originator makes the video capture template option selections, the originator or developer edits the video capture template itself through a template editor. In this way, the originator or developer can advantageously adjust the available templates. In such embodiments, the content capture engine 120 receives a video capture template selection from the originator or a developer prior to causing the originator's client device to present the video capture template. The video capture template selection configures the at least two video capture interface options of the video capture template.

The content production engine 140 receives the raw audiovisual data segments from each recipient and applies a production ruleset to the raw audiovisual data segments and renders the same, thereby creating one or more content blocks. For example, the content production engine 140 may normalize the audio and/or video components of the audiovisual data segments, detect and trim a silent portion from a beginning of each audiovisual data segment, trim a beginning portion and/or an end portion of each audiovisual data segment, stitch together a plurality of audiovisual data segments with interstitial graphics, add music to the stitched-together audiovisual data segments, insert an introduction before the audiovisual data segments, insert an outro after all of the audiovisual data segment, and/or apply graphics over the audiovisual data segments. In this representative example, the content production engine 140 thus creates a professional happy birthday message to John from all the colleagues in his department. Optionally, a feedback loop 118 may send to each recipient either the content block or a rendered portion of the content block corresponding to that recipient's raw audiovisual data segment. The recipient may then accept the content block, re-record the audiovisual data segment, or delete the portion of the content block corresponding to their audiovisual data segment. If the recipient re-records or deletes the audiovisual data segment, the content block is re-edited and re-rendered prior to delivering the final content block to the one or more recipient client devices.

The content delivery engine 160 receives the rendered content block from the content production engine 140 and delivers the same to one or more recipients at the time and date predetermined by the originator. In this representative example, the content delivery engine 160 delivers the group birthday message to John.

As another example, the audiovisual content creation system 100 is configured as a brand promotion tool. The content capture engine prompts an originator or a recipient to select a brand (for example, a footwear or apparel company); however, in some embodiments, the brand is fixed and may not be adjusted by the recipient. Then, the content capture engine prompts the originator or recipient to select an Interviewer (for example, an athlete affiliated with said footwear or apparel company). Based upon the originator's or recipient's selections, the content capture engine “interviews” then presents a video capture interface to one or more recipients by delivering (via the display and audio components of the client device) a series of pre-recorded video prompts of the selected Interviewer (in this example, the athlete) asking a series of questions to the recipient about a particular topic (for example, the brand or its products). The client device records the recipient's answers to these questions as raw audiovisual data segments. These video segments are then received and edited by the content production engine into one or more content blocks. The content delivery engine then delivers the content block(s) to the recipient to share on social media and the brand recipient (for example, the corporate entity which owns the brand), which may choose the best content submissions for marketing purposes or for other purposes.

As another example, the audiovisual content creation system 100 is configured as a documentary capture tool that enables a recipient to create a documentary of their own life. Accordingly, the content capture engine first prompts the recipient to select a topic or genre (for example, the early years, greatest hits, professional life etc.). Then, the content capture engine prompts the recipient to select a (Director) Interviewer (for example, a celebrity). Based upon the recipient's selections, the content capture engine “interviews” the recipient by delivering a series of pre-recorded video prompts of the selected Interviewer asking a series of template-based questions to the recipient about the recipient's life. Then, the application delivers the questions according to the video creation template, i.e., particular questions, in a particular order, and in a particular way. The client device records the recipient's answers to these questions as raw audiovisual data segments. These video segments are then edited by the content production engine into one or more content blocks, i.e., a complete documentary. The template also has preset answer length limits for the recipients. The content delivery engine then delivers the complete documentary to one or more selected recipients (such as the recipient's grandchildren) based upon a delivery trigger (such as a posthumous deliver trigger).

As still another example, the audiovisual content creation system 100 is configured as a television show simulation tool that enables a recipient to “participate” in a television show. Accordingly, the content capture engine first prompts the recipient to select a theme (for example, a well-known television show). Optionally, the content capture engine prompts the recipient to select a topic based upon the selected theme (for example, if the selected theme is a well-known sports show, then the content capture engine prompts the recipient to select baseball, football, or another sport) and/or an Interviewer (in this example, an anchor of the sports show). Based upon the recipient's selections, the content capture engine “interviews” the recipient by delivering a series of pre-recorded video prompts of the selected Interviewer asking a series of template-based questions to the recipient about the selected topic (for example, the selected sports) and consistent with the selected theme (for example, from the studio of the selected sports show). In this example, the template-based questions may include one or more questions based upon the selected sports show theme, such as “How are you preparing for the big game?” The client device records the recipient's answers to these questions as raw audiovisual data segments. These video segments are then edited by the content production engine into a finished content block, i.e., a full interview of the selected sports show. The content delivery engine then delivers the final interview to one or more selected recipients, for example to the recipient's teammates and/or to the corporate entity which owns the selected theme.

As still another example, the audiovisual content creation system 100 is configured as a game-creation tool that enables one or more recipients (an interviewer) to select or create a series of questions (such as by recording video prompts and/or inputting the questions as text) and optionally to determine one or more parameters of the selected/created questions, for example how much time “players” have to answer those questions. Based upon the selected questions, the audiovisual content creation system 100 produces a game, and delivers the same to one or more recipient “players” (for example, the recipient's friends and/or family). To play the game, the recipients initiate the game, which causes the video prompts and/or textual questions to appear on a display of the recipient's playback device (which may also act as a client device); after the question is presented, the camera on the recipient's playback/recording device turns on and records the recipient's response for the fixed amount of time and then turns off. In some embodiments, the recipients do not have any option to redo their answer(s), for added fun. After the game is complete, the audiovisual content creation system 100 produces all of the questions and responses into a finished content block, which may appear as a live game between the interview and the players.

The foregoing use-cases are representative, not limiting, and are intended to convey the scope of the video capture systems described herein. Other use cases include, but are not limited to: simulating a recipient's participation in a game show, creating greeting cards for delivery to select recipients, creating documentaries of a recipient's travels or other experiences, creating a video resume' of a recipient's career, creating a video dating profile of the recipient, and other use cases.

### Content Capture Engine

FIG. 2 illustrates portions of an audiovisual content creation system 200, and in particular a content capture engine 220 thereof, as well as methods of producing audiovisual content. Audiovisual content creation system 200 has the same features as the audiovisual content creation system 100 of FIG. 1. Each process block described below may be implemented as a method step or may be implemented as a module of software logic (e.g., executable software code), firmware logic, hardware logic, or various combinations thereof stored on a non-transitory computer-readable medium (e.g., a data store) of a client device (e.g., a smartphone) and/or a server or other network storage device communicatively connected to the client device. Accordingly, each module described herein is configured to execute the methods described with respect to those modules when executed by a processor of the client device and/or other network element. However, it is not essential that the same client device execute every step or block of the content capture engine 220.

The content capture engine 220 generally receives inputs from an originator and at least one recipient. The originator causes one or more recipients to receive the video capture interface on their client device. The originator may or may not be a recipient, and may or may not receive the final content block.

The content capture engine 220 is periodically described below in different use case contexts, such as an enterprise communication platform, a brand promotion tool, or a documentary capture tool. However, it shall be appreciated that the content capture engine 220 is not limited to the use cases described, and is applicable to many different use cases, including but not limited to the use cases introduce above.

At step 224, content capture engine 220 causes a client device of the originator to present a video capture template on a display thereof prior to causing the client device of the recipient to present the video capture interface on the display of the client device(s) of the recipient(s).

The video capture template presents the originator at least two video capture interface options in an onboarding module. The video capture interface options include onboarding information options. Initially, the onboarding module presents one or more user interfaces on the originator's client device that prompt the originator to provide (such as by typing or speaking) onboarding information, which may relate to the originator, to one or more recipients, or may be general system preferences. Onboarding information may include any one or more of the following types of information: a theme, a style, an interviewer, a brand, an audience (single/group), date of birth, legal name, email address, phone number, current mailing address, current home address, past home addresses, gender, family members, interests, experiences, preferred musical genres, preferred graphic styles, social medial accounts, and/or other third party accounts. The originator provides this information, which is received and stored by the audiovisual content creation system 200.

The onboarding module also prompts the originator to input a delivery option for delivering the final content block at a scheduled date and time, upon the occurrence of an event, or instantaneously upon completion of the content block. In some embodiments, the onboarding module is configured to onboard one or more recipients to the audiovisual content creation system initially and/or for a specific video capture after an initial onboarding.

An optional capture mode module prompts the originator to select a capture mode, such as one of the following capture modes: a guided self-video mode or a guided message to others mode. The guided message to others mode includes many sub-modes, for example one originator-to-one recipient, one originator-to-many recipients, many originators-to-many recipients, and many originators-to one recipient. In some embodiments, the capture mode is predetermined and not selectable by the recipient.

Optionally, based upon the selection of either the guided self-video mode or guided video to others mode, the onboarding module prompts the originator to select a question series or to create their own questions, such as by typing questions into a text box. In some embodiments, the question series are predetermined based upon the theme or capture mode selected by the originator and are not selectable by the recipient. For example, when the originator selects a birthday theme, the question series may be fixed and may include questions such as, “What birthday message would you like to share with [recipient]?” or “What positive attribute comes to mind when you think about [recipient]?”

In the example of a documentary creation tool, representative question series include but are not limited to a) “your childhood” b) “your career” c) “your family,” and the like. In some embodiments, a menu of available question series and/or particular questions within one or more question series is based upon the personal information provided by the recipient to the onboarding module. For example, if the recipient indicated that the recipient is a veteran in the onboarding module, then the question series menu may include a question series called “Your military service,” which may include a question such as, “Who was your closest friend in the service?” In some embodiments, the selection of the question series is part of the onboarding information.

As another example, if the onboarding information included the selection of a brand, then the question series is based upon the selected brand (for example, questions about the recipient's experiences with the brand or its products). In another example, if the onboarding information included the selection of a theme (such as a well-known TV show), then the question series is based upon questions consistent with the theme (for example, questions asked by a character of the TV show). Advantageously, because the question series is based upon the onboarding information, the questions are more relevant to the recipient.

As still another example, in an embodiment, the originator selects a “game mode,” e.g., a guided video to others mode (for example, one-to-many). The content capture engine 220 prompts the recipients to select or create their own series of questions (such as by recording video prompts and/or inputting the questions as text) and optionally to determine one or more parameters of the selected/created questions, for example how much time “players” have to answer those questions.

Optionally, based upon the onboarding information and/or based upon a predetermined parameter, the content capture engine 220 prompts the originator to select an Interviewer, i.e., a person or character who will “interview” the recipient by asking the questions from the question series as pre-recorded video prompts. In some embodiments, the Interviewer is predetermined based upon the onboarding information and not selectable by the originator. In either case, the Interviewer is based upon the onboarding information, for example the selected theme or brand. In some embodiments, the Interviewer is selectable by gender, nationality, appearance, age, voice, or other characteristic. In some embodiments, the selection of the Interviewer is part of the onboarding information.

In the example of an enterprise communication platform, the content capture engine 220 may prompt the originator to select an Interviewer from a menu of one or more employees of the enterprise, for example the CEO. In the example of a documentary creation tool, the content capture engine 220 may prompt the originator to select an Interviewer from a menu of one or more celebrities. As another example, if the onboarding information included the selection of a brand, the Interviewer is based upon the selected brand (for example, an athlete affiliated with the selected brand). As another example, if the onboarding information included the selection of a theme (a well-known TV show), then the Interviewer is based upon the selected theme (for example, a character or host of the TV show). Advantageously, because the Interviewer is based upon the onboarding information, the recipient will be more familiar and comfortable.

In the previously introduced “game” mode example, the recipient is the Interviewer.

After the originator provides the onboarding information, including selecting the theme, style, and recipients, then the originator initiates the capture, i.e., initiates step 226, causing one or more client devices to present a video capture interface on a display of thereof. The video capture interface is based on the one or more video capture template option selections, and presents or displays at least one question to the recipient and prompts the recipient to record an audiovisual data segment. Optionally, the video capture interface prompts the recipient to enter a text response to the at least one question, such as with the keyboard of the client device.

At step 226, the content capture engine 220 generally utilizes a display, image sensor and microphone of the client device (such as the built-in camera and microphone of the client device of one or more recipients) to present one or more questions based upon the onboarding information and to capture images, video, and audio of one or more recipient's responses to those questions, which are stored on the client device and/or on a network-based data store. Optionally, the content capture engine 220 utilizes the keyboard of the client device to capture text inputs from the recipient. It shall be appreciated that in any module described herein, the client device or other network-based data store captures and stores the recipient's spoken and physical expressions inputs as audiovisual data segments.

On the client device(s) of the recipients, the content capture engine 220 displays the video capture interface, such as through a web browser. Optionally, the video capture interface delivers a priming sequence to the recipient, based upon the onboarding information, the Interviewer, and the question series. The priming sequence puts the recipient in the appropriate state of mind for that question series (e.g., calm and contemplative) prior to creation of the audiovisual data segments, and gets the recipient comfortable with the Interviewer and with the process of recording audiovisual data segments through the audiovisual content creation system 200. Accordingly, the priming sequence includes one or more pre-recorded video messages of the Interviewer delivering a priming message to the recipient and/or asking the recipient one or more topical priming questions. For example, if the onboarding information included a recipient-selected theme (for example, a well-known TV show), and a recipient-selected Interviewer (the host of that TV show), then the priming includes an introductory message or question delivered as a pre-recorded video prompt of the Interviewer consistent with the selected theme (for example, “what is your first memory of the show?”). If the priming sequence includes a priming question, then the content capture engine 220 records the recipient's response.

After optional priming, the content capture engine 220 begins to present questions to the recipient based upon the onboarding information and the selected Interviewer. For example, the content capture engine 220 delivers pre-recorded video prompts of the selected Interviewer asking the questions in the question series. In the example context of a documentary creation tool, the question series include questions based upon the recipient's life, as determined from the onboarding information. In response, the recipient speaks the appropriate answers and the camera and microphone of the client device records those answers, thus creating audiovisual data segments. In the previously-introduced “game” mode example, the content capture engine 220 prompts the recipient(s) to record their questions as audiovisual data segments, which will be delivered to one or more recipients.

In some embodiments, to increase the recipient's trust in the audiovisual content creation system 200, the recipient initiates recording of the answer, for example by tapping a “record” button on the video capture interface of the client device. In some embodiments, each audiovisual data segment includes the recipient's answer to one question of the question series. Optionally, the recipient has the ability to re-record any answer to any question. In some embodiments, the content capture engine 220 presents the recipient an option to create a custom question; in such embodiments, the content capture engine 220 presents that custom question to the recipient as text on a display screen and/or as a question asked by the Interviewer.

Optionally, after the content capture engine 220 records the recipient's answers to each question of the question series, the content capture engine 220 delivers a post-question tutorial to the recipient, which includes a pre-recorded video prompt from the Interviewer with instructions on how to complete the video creation process, and how to deliver the resulting documentary to one or more recipients.

Optionally, the content capture engine 220 prompts the recipient to select a theme (including graphic style and/or music) after delivering the question series, if a theme was not selected in the onboarding information. The selected theme will be implemented in the final content block. In some embodiments, the content capture engine 220 suggests to the recipient a default theme which is based upon the onboarding information. For example, if the recipient indicates a preference for classical music in the onboarding module, then the default theme may include elegant graphics and orchestral music. Optionally, content capture engine 220 prompts the recipient to upload additional media, such as photos and videos which are associated with the recipient's answers to the questions of the question series. In such embodiments, the content capture engine 220 prompts the recipient to indicate which answer is associated with which media.

Optionally, the content capture engine 220 also prompts the recipient to select a delivery option to deliver the final content block to one or more recipients, if a delivery option was not selected by the originator. Representative delivery options include: a “deliver now” option, a “schedule future delivery” option in which the content block is delivered to the selected recipients at a scheduled date or time, or an “event driven delivery” option triggered by a third party.

In the example context of a documentary creation tool, one “event driven delivery” option is an “afterlife delivery” option, which prompts the audiovisual content creation system 200 to archive the final documentary until the occurrence of a posthumous delivery trigger. Afterlife delivery allows recipients to schedule delivery of their videos for after their passing, and in particular upon execution of a posthumous delivery trigger. Accordingly, the recipient identifies one or more beneficiaries who will receive the final documentary. In addition, the recipient identifies one or more executors of their “digital estate” (which includes the final documentary), who are empowered to distribute the final documentary to the beneficiaries after the recipient's death. The executor(s) are provided with authority to access the audiovisual content creation system 200 following the recipient's death, and to initiate delivery of the final documentary. The posthumous delivery trigger includes, for example, an affirmative instruction by the executor, receipt and validation of a death certificate of the recipient from one the beneficiary, or other trigger.

Other event driven delivery options are contemplated in other applications of the audiovisual content creation systems disclosed herein.

Optionally, as part of the delivery options, the content capture engine 220 may prompt the recipient to select one or more recipients of the final content block if the originator did not previously do so. In the example context of a documentary creation tool, recipients may include: all family; all friends; select individuals; and publicly release. In some embodiments, the identities of family and friends is based upon the onboarding information, for example specific names provided by the recipient and/or social media accounts. In another example in which the audiovisual content creation system 200 is configured as a brand promotion tool, the selected recipients include the brand itself and optionally one or more family and/or friends.

After completing the foregoing steps, the recipient completes the capture process (such as by pressing a “finalize” option on the video capture interface), which prompts the audiovisual content creation system 200 to produce the a content block based upon the recorded audiovisual data segments. This prompt begins the production process, which precedes delivery of the final content block.

### Content Production Engine

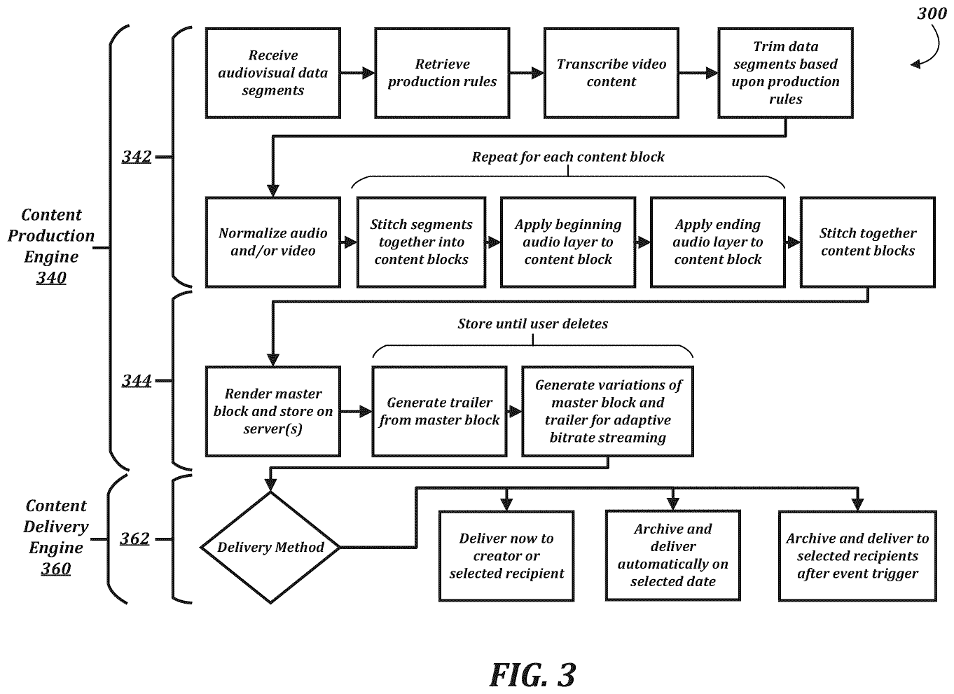

FIG. 3 illustrates portions of an audiovisual content creation system 300, and in particular a content production engine 340 and a content delivery engine 360 thereof. Audiovisual content creation system 300 has the same features as the audiovisual content creation systems of FIG. 1 and FIG. 2.

At step 342, content production engine 340 receives the raw audiovisual data segments captured by the content capture engine, and transforms those audiovisual data segments into final “content blocks” for delivery to the originator's selected recipients. As with the content capture engine 220 described above, each process block described below is implemented as a method step or a module of logic, e.g., software logic. In the embodiments described, modules of the content production engine 340 and content delivery engine 360 are configured to be executed by computing devices such as one or more serverless and/or server-based architectures communicatively connected to the recipient's client device.

Initially, the content production engine 340 receives raw audiovisual data segments from the content capture engine, i.e., the recipient's recorded answers to the presented questions.

The content production engine 340 stores and applies a production ruleset that includes production rules for editing and producing content blocks based upon the audiovisual data segments. Representative rules include any one or more of: normalizing a video component of the audiovisual data segment, normalizing an audio component of the audiovisual data segment, detecting and trimming a silent portion of the audiovisual data segment, trimming at least one of a beginning portion or an end portion of the audiovisual data segment, stitching the audiovisual data segment with a second audiovisual data segment or an interstitial graphic, adding a music layer before, during, or after the audiovisual data segment, or adding graphics to the audiovisual data segment. In some embodiments, the production ruleset includes trimming at least one of the beginning portion or the end portion of the audio visual data segment and adding graphics to the audiovisual data segment.

The content production engine 340 carries out further production steps based at least in part upon the production ruleset. In some embodiments, the production ruleset is also based upon the onboarding information provided by the originator in the content capture engine (for example, the selected theme or brand, which determine the graphics and music for the final content block(s)).

Optionally, content production engine 340 generates a transcript of the raw audiovisual data segments, for example using Google Speech to Text API or similar. The transcript is useful for searching and closed captioning.

In embodiments where the production ruleset includes trimming the audiovisual data segment, the content production engine 340 trims the raw audiovisual data segments to eliminate excess dead time at the beginning and/or end of each raw audiovisual data segment. In some embodiments, the content production engine 340 trims answer margins by frames (for example, by 10 silent frames preceding hearing answer audio), and/or detects and trims a silent portion of the data segment preceding the spoken audio. As part of this process, in some embodiments, content production engine 340 measures ambient noise during a “silence” sample, then applies noise cancelation to remove background noise in the audiovisual data segments.

Because the recipient(s) may have recorded different audiovisual data segments at different times, in different places, etc., the raw audiovisual data segments may have different audio and video levels. In embodiments where the production ruleset includes trimming the audiovisual data segments, content production engine 340 normalizes the audio and/or video components across the raw audiovisual data segment, such as to a common decibel level, a common brightness level, and the like.

In embodiments where the content production engine 340 receives more than one audiovisual data segment, the content production engine 340 stitches together two or more audiovisual data segments to create a cohesive “content block.” For example, in some embodiments, a content block includes a plurality of questions and answers a common topic in the question series. In some embodiments, a content block is based upon two or more audiovisual data segments with answers to a same interview question, in which case, the content production engine 340 extracts the highest production quality content from the audiovisual data segments and creates a high quality auto-edited interview answer. Other forms of content blocks include question blocks, answer blocks, and primer blocks. In some embodiments, questions and corresponding answers are connected as one content block with an audio layer selected for that content block by the originator or the production ruleset.

In some embodiments, the content production engine 340 creates content blocks by breaking open-ended questions into multiple questions, and stitching together audiovisual data segments corresponding to the answers of the multiple questions.

In some embodiments, to enhance the production value of the content block, the content production engine 340 applies a beginning audio layer and/or an ending audio layer (e.g., intro and outro musical pieces or silent periods) based upon the production ruleset. Optionally, the content production engine 340 applies transitions or interstitial graphics between audiovisual data segments of the content block, which are based upon the onboarding information (e.g., theme and style) and the production ruleset, including type (for example: audio/video; fade to/from; black/white; crossfade; hard cut), length, speed, and/or margin.

After creation of all the content blocks, the content production engine 340 stitches together the content blocks to create a content master block. In particular, the content production engine 340 stitches the content blocks together in a logical order, such as by topic, chronologically, in order of the question series, etc.

At step 344, the content production engine 340 renders the content master block with graphics, music, effects, and the like in order to create the finished complete documentary. In some embodiments, the content master block is rendered at least partially in a server-less architecture in order to accelerate rendering times; in such embodiments, the content block is at least partially rendered without storing the content block in a volatile memory.

Optionally, to facilitate preview and delivery, the content production engine 340 automatically creates a trailer (for example, a 30 second clip) of the content master block, in addition to different variations of the content master block for adaptive bitrate streaming.

As one example, in the context of an enterprise communication platform, the master content block has the appearance of a fully-produced message to an employee from colleagues. As another example, in the context of a documentary creation tool, the final content block has the appearance of a fully-produced video interview between the Interviewer and the recipient. In the context of a brand promotion tool, the final content block may have the appearance of the recipient participating in television commercial featuring the brand's product or services. In the context where the selected theme is a well-known television show, the final content block has the appearance of a mini-episode of the television show featuring the recipient. These examples are representative, not limiting.

### Content Delivery Engine

At step 362, content delivery engine 360 manages the delivery of one or more complete content blocks, based upon the originator's selected delivery preference in content capture engine (described above). In some embodiments, the content delivery engine 360 delivers the content blocks “on-platform,” such as by hosting such content blocks and enabling one or more recipients to access the content via a browser-based client. In some embodiments, the content delivery engine 360 delivers the content blocks “off-platform,” such as by sending the content blocks to one or more third party platforms, such as third party social media platforms. In some embodiments, the content delivery engine 360 delivers directly to one or more recipients directly (e.g., by text, email, or similar channels). In some embodiments, the content delivery engine 360 delivers the content blocks to one or more recipients via third party platforms (e.g., social media platforms). When the originator has selected immediate delivery, the content delivery engine 360 promptly delivers the complete video to the selected recipients, for example by sending an automated message that includes a link to the video or via the platform itself. Recipients can also share the completed videos on other platforms.

If the originator instead opts to schedule a later delivery or event-driven delivery, then the content delivery engine 360 encrypts and archives the complete documentary on a long-term storage medium, until arrival of the scheduled delivery date or the occurrence of a relevant event which is triggered by a third party. As one example, an event-driven delivery includes a delivery request from the recipient, for example the organization which owns the designated brand. As another example, an event-driven delivery includes the execution of a posthumous delivery trigger by an executor of the recipient. These event-driven delivery examples are representative, not limiting.

In some embodiments of the previously-introduced “game” mode example, the content delivery engine 360 delivers the content blocks of questions to one or more recipient “players,” who answer use their playback device as a recording device to record one or more audiovisual data segments of their answers. In some embodiments, the content delivery engine 360 presents the recipient(s) with a fixed amount of time to answer the questions, where the question is posed and the camera turns on and records for a preset amount of time (for example, 5 seconds), so the recipient answers questions quickly (such as with first knee jerk responses). Thus, in such embodiments, recording is performed both by the Interviewer/Director and by the recipients. In some such embodiments, the audiovisual data segments captured by the recipients are returned to the content production engine, which assembles audiovisual data segments from both the Interviewer/Director and the recipients into one or more content blocks. Optionally, the recipient(s) utilize the content capture engine on their own client devices to create the audiovisual data segments, which are combined by the content production engine with the audiovisual data segments of the Interviewer/Director to create one or more final content blocks.

FIG. 4 shows a representative high-level architecture of an audiovisual content creation system 400 according to an embodiment of the present disclosure.

The content capture engine 420 is implemented partially on a client device as well as through a web application hosted on cloud-based architecture. In particular, a client device of an originator includes an application 428 installed thereon, for example as a bot on a messaging or communication platform installed on the client device. The client device application 428 presents the originator with at least one video capture template option selection that enables the originator to initiate the capture, e.g., selecting a theme, a style, and recipients. Optionally, the client device application 428 presents the originator additional options, such as whether the originator will be a recipient of the video capture interface.

After the originator initiates the capture through the client device application 428, the designated recipients receive, on their respective client devices, a notification through a recipient client device application 430 to access the web-based application 432, which causes each recipient's client device to present a video capture interface as previously described, e.g., through a browser window. Each recipient completes the capture process via the web application 432 and/or through the recipient client device application 430.

The content production engine 440 is located on the cloud-based architecture and receives the raw audiovisual data segments as previously described. The content production engine 440 executes one or more backend functions 446, such as associating the received raw audiovisual data segments with an account of the recipient. Additionally, a production engine 448 edits the one or more audiovisual data segments according to the production ruleset. Finally, a render engine 450 renders the edited audiovisual data segments (e.g., on a server-less architecture to increase speed and reduce cost), thus rendering one or more content block(s).

The rendered content blocks are stored in a media storage layer 464 as part of the content delivery engine, for delivery in accordance with the originator's original determination.

Accordingly, the audiovisual content creation systems of the present disclosure enable the rapid production of compelling, fully-produced audiovisual content and the timely distribution of such content to recipients in many use cases.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near.” etc., mean plus or minus 5% of the stated value. For the purposes of the present disclosure, the phrase “at least one of A, B, and C.” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

In an embodiment, circuitry includes one or more ASICs having a plurality of predefined logic components. In an embodiment, circuitry includes one or more FPGA having a plurality of programmable logic components. In an embodiment, circuitry includes hardware circuit implementations (e.g., implementations in analog circuitry, implementations in digital circuitry, and the like, and combinations thereof). In an embodiment, circuitry includes combinations of circuits and computer program products having software or firmware instructions stored on one or more computer readable memories that work together to cause a device to perform one or more methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like. In an embodiment, circuitry includes a baseband integrated circuit or applications processor integrated circuit or a similar integrated circuit in a server, a cellular network device, other network device, or other computing device. In an embodiment, circuitry includes one or more remotely located components. In an embodiment, remotely located components are operatively connected via wireless communication. In an embodiment, remotely located components are operatively connected via one or more receivers, transmitters, transceivers, or the like.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In an embodiment, circuitry includes one or more recipient input/output components that are operatively connected to at least one computing device to control (electrical, electromechanical, software-implemented, firmware-implemented, or other control, or combinations thereof) one or more aspects of the embodiment.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical.” “horizontal,” “front,” “rear,” “left,” “right,” “top.” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A computer-implemented method of producing audiovisual content, comprising:
causing a client device to present a video capture interface on a display of thereof, the video capture interface presenting at least one question and prompting a recipient to record an audiovisual data segment;
receiving the audiovisual data segment recorded on the client device;
producing a content block based upon the audiovisual data segment, wherein producing the content block comprises editing the audiovisual data segment based upon a production ruleset; and
causing the content block to be delivered to one or more recipient devices.

2. The computer-implemented method of claim 1, wherein the video capture interface prompts the recipient by displaying a pre-recorded audiovisual data segment.

3. The computer-implemented method of claim 2, wherein the at least one question presented on the video capture interface is presented in the pre-recorded audiovisual data segment.

4. The computer-implemented method of claim 2, wherein the video capture interface prompts the recipient to enter a text response to the at least one question.

5. The computer-implemented method of claim 2, wherein the one or more recipient devices include the client device.

6. The computer-implemented method of claim 2, wherein the video capture interface presents a plurality of questions including the at least one question, wherein receiving the audiovisual data segment recorded on the client device comprises recording a plurality of audiovisual data segments including the audiovisual data segment.

7. The computer-implemented method of claim 6, wherein the production ruleset comprises stitching together the plurality of audiovisual data segments.

8. The computer-implemented method of claim 1, further comprising:
causing a second client device to present a video capture template on a display thereof prior to causing the client device to present the video capture interface, wherein the video capture template presents at least two video capture interface options;
receiving a video capture template option selection from the second client device, wherein the video capture template option selection comprises at least one option selection selected from the group consisting of: a number of recipients, a genre, and a style;
wherein the video capture interface presented on the client device is based on the video capture template option selection.

9. The computer-implemented method of claim 8, further comprising:
receiving a video capture template selection prior to causing the second client device to present the video capture template on the display thereof,
wherein the video capture template selection configures the at least two video capture interface options of the video capture template.

10. The computer-implemented method of claim 1, wherein the production ruleset includes at least one production rule selected from the group consisting of: normalizing a video component of the audiovisual data segment, normalizing an audio component of the audiovisual data segment, detecting and trimming a silent portion of the audiovisual data segment, trimming at least one of a beginning portion or an end portion of the audiovisual data segment, stitching the audiovisual data segment with a second audiovisual data segment or an interstitial graphic, adding a music layer before, during, or after the audiovisual data segment, or adding graphics to the audiovisual data segment.

11. The computer-implemented method of claim 10, wherein the production ruleset includes trimming at least one of the beginning portion or the end portion of the audiovisual data segment and adding graphics to the audiovisual data segment.

12. The computer-implemented method of claim 1, wherein editing the audiovisual data segment based upon the production ruleset comprises detecting and trimming a silent portion of the audiovisual data segment.

13. The computer-implemented method of claim 12, wherein editing the audiovisual data segment based upon the production ruleset comprises normalizing at least one of a plurality of audio components or a plurality of video components of the audiovisual data segment.

14. The computer-implemented method of claim 1, further comprising transmitting the content block to the client device and re-editing the content block after producing the content block and prior to causing the content block to be delivered to one or more recipient client devices.

15. The computer-implemented method of claim 1, wherein the client device is caused to present the video capture interface in response to a video capture template option selection by an originator.

16. A method of producing audiovisual content, comprising:
originating a video capture interface presenting at least one question on a display of a client device, wherein the video capture interface prompts a recipient to record an audiovisual data segment responsive to the at least one question;
recording, on the client device, the audiovisual data segment responsive to the at least one question;
causing a content block to be produced based upon the audiovisual data segment recorded on the client device, wherein producing the content block comprises editing the audiovisual data segment based upon a production ruleset; and
causing the content block to be delivered to one or more recipient devices.

17. The method of claim 16, wherein the video capture interface prompts the recipient by displaying a pre-recorded audiovisual data segment.

18-20. (canceled)

21. The method of claim 17, wherein the video capture interface presents a plurality of questions including the at least one question, wherein receiving the audiovisual data segment recorded on the client device comprises recording a plurality of audiovisual data segments including the audiovisual data segment.

22. The method of claim 21, wherein the production ruleset comprises stitching together the plurality of audiovisual data segments.

23-30. (canceled)

31. An audiovisual content creation system, comprising:
a content capture engine and a content production engine, each comprising a processor and a non-transitory computer-readable medium,
wherein the content capture engine stores logic on the non-transitory computer-readable medium that, in response to execution by the processor, performs actions, including:
causing a client device to display a video capture interface, wherein the video capture interface prompts a recipient to record an audiovisual data segment responsive to the at least one question; and
causing the client device to record the audiovisual data segment;
wherein the content production engine stores logic on the non-transitory computer-readable medium that, in response to execution by the processor, performs actions, including:
producing a content block based upon the audiovisual data segment recorded on the client device, wherein producing the content block comprises editing the audiovisual data segment based upon a production ruleset.
